(19) United States
(12) Patent Application Publication
(10) Pub. No.: US 2014/0306571 A1
(43) Pub. Date: Oct. 16, 2014

(54) POLE SEPARATOR INSERT FOR ELECTRIC MACHINE STATOR

(71) Applicant: HAMILTON SUNDSTRAND CORPORATION, Windsor Locks, CT (US)

(72) Inventors: Joseph Kenneth Coldwate, Roscoe, IL (US); Wilfredo E. Colon Velazquez, South Beloit, IL (US)

(73) Assignee: Hamilton Sundstrand Corporation, Windsor Locks, CT (US)

(21) Appl. No.: 13/861,015

(22) Filed: Apr. 11, 2013

(51) Int. Cl. H02K 3/34

(52) U.S. Cl. CPC H02K 3/34
USPC 310/215

(57) ABSTRACT

A pole separator insert is employed in a stator assembly of an electric machine to separate winding coils installed within circumferentially distributed slots of a stator core. The pole separator insert comprises first and second insulating tabs connected by first and second legs. The first and second insulating tabs are disposed between adjacent winding coils of a single phase, at opposite ends of the stator core. The first and second legs are disposed through adjacent circumferentially distributed slots of the stator core.

### BACKGROUND

The present invention is related to electric machines and in particular to stator assemblies of electric machines.

Electric machines typically include a rotating portion called a rotor and a stationary portion called a stator that includes a plurality of windings. In an electric motor, the stator windings receive electrical energy that generates a rotating magnetic field, which interacts with the rotor to generate mechanical energy. In an electric generator, mechanical energy supplied to a rotor causes a magnetic field (generated by the rotor) to rotate and interact with the stator windings to generate electric energy. In an electric motor, electrical energy supplied to the stator windings creates an electric field to interact with either the rotor windings or permanent magnets causing the rotor rotate and generate mechanical energy. The stator typically includes a plurality of phase windings (e.g., three-phase) for either receiving a three-phase AC input voltage in motoring application or for providing a three-phase AC output in generating applications. Each phase typically constitutes a plurality of winding coils (e.g. four-coil). Stator windings are sometimes laminated, sheathed, or enameled to prevent unwanted electrical contact between stator windings. In some instances, these precautions may not be sufficient to prevent shorts between adjacent coils of stator windings.

### SUMMARY

In a first embodiment of the present invention, a pole separator insert is employed in a stator assembly of an electric machine to separate winding coils installed within circumferentially distributed slots of a stator core. The pole separator insert comprises first and second insulating tabs connected by first and second legs. The first and second insulating tabs are disposed between adjacent winding coils of a single phase, at opposite ends of the stator core. The first and second legs are disposed through adjacent circumferentially distributed slots of the stator core.

In a second embodiment of the present invention, a stator assembly for an electrical machine comprises a substantially cylindrical stator core, first and second conductive winding coils, and a pole separator insert. The substantially cylindrical core has a plurality of circumferentially distributed, axially extending slots including a first stator slot, a second stator slot, a third stator slot, and a fourth stator slot adjacent the third stator slot. The first conductive winding coil is wound through the first and third stator slots. The second conductive winding coil is of the same phase as the first conductive winding coil, and is wound through the second and fourth stator slots. The pole separator insert comprises first and second insulating tabs separating the first conductive winding from the second conductive winding coil, and first and second legs connecting the first and second insulating tabs, and extending through the third and fourth stator slots, respectively.

### BRIEF DESCRIPTION OF THE DRAWINGS

FIG. 1 is a perspective view of pole separator insert for a stator assembly, according to an embodiment of the present invention.

FIG. 2 is an end view of a stator assembly illustrating the location of the pole separator insert of FIG. 1 between adjacent windings.

### DETAILED DESCRIPTION

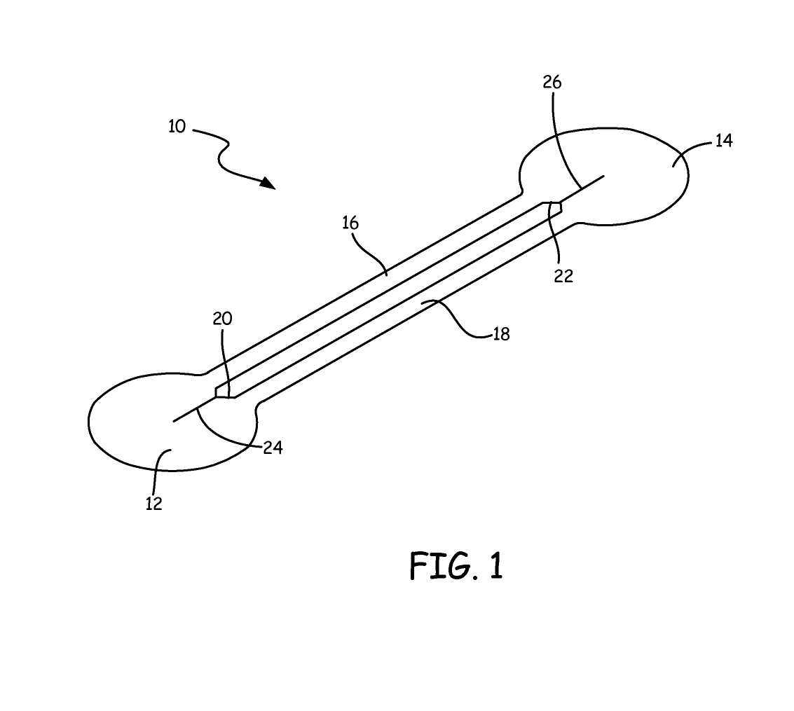

FIG. 1 illustrates pole separator insert 10, which has insulating tabs 12 and 14, legs 16 and 18, intra-leg sections 20 and 22, and slits 24 and 26. Pole separator insert is an insulator for use in the stator of an electrical machine to prevent shorts between adjacent winding coils of neighboring poles of a single phase. In the depicted embodiment, pole separator insert 10 is a unitary construction stamped or cut from a single piece of flexible insulating material. In alternative embodiments, pole separator insert 10 may be a multi-piece construction wherein at least insulating tabs 12 and 14 are formed of insulating material. Coil separator 10 may, for instance, be formed of electrical insulator paper or polymer such as a dielectric paper or film.

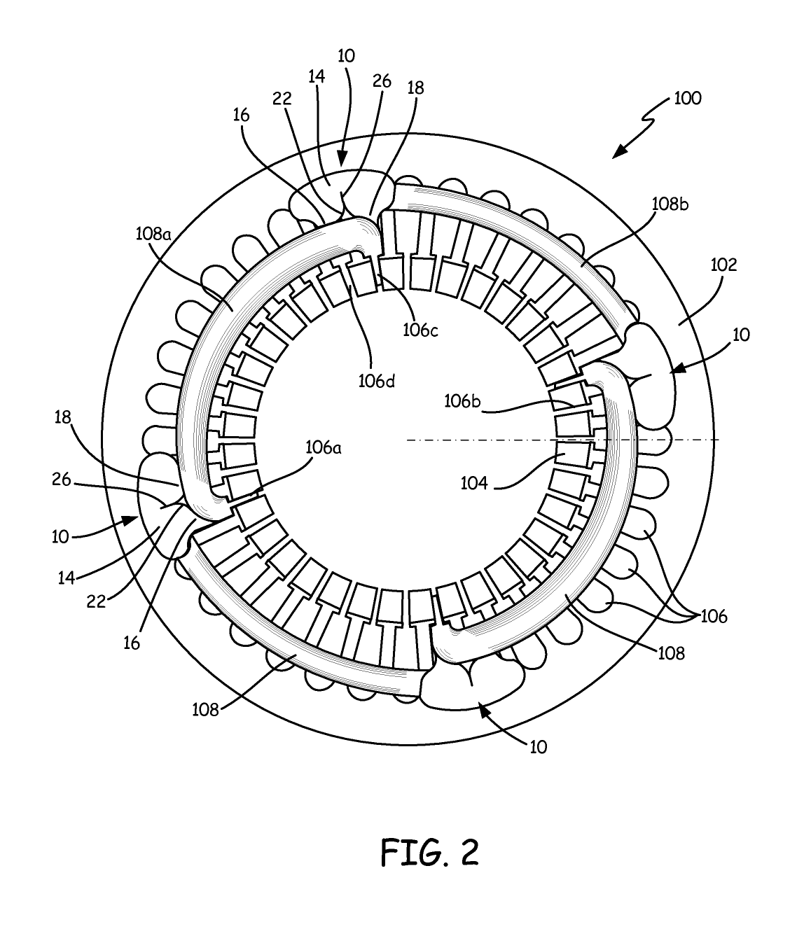

Insulating tabs 12 and 14 of pole separator insert 10 are insulators configured to separate adjacent winding coils of neighboring poles of a single phase, as discussed in further detail below with respect to FIG. 2. Insulating tabs 12 and 14 are connected by legs 16 and 18, which are separated by intra-leg sections 20 and 22 on insulating tabs 12 and 14, respectively. Legs 16 and 18 extend through neighboring slots of a solid stator core of an electrical machine (see FIG. 2), thereby retaining insulating tabs 12 and 14 in position between adjacent stator coils to prevent electrical breakdown. Legs 16 and 18 allow pole separator insert 10 to be installed at a desired location without requiring an installer to maintain the position of insulating tabs 12 and 14 until windings can be secured into a final installation position. In the depicted embodiment, insulating tabs 12 and 14 are substantially circular insulating discs. This shape is selected for ease of manufacture and to reliably separate adjacent coils of neighboring poles of stator windings, despite tolerances in installation positions of adjacent stator coils. In alternative embodiments, insulating tabs 12 and 14 may take other shapes, including substantially triangular or semicircular shapes.

Legs 16 and 18 are straight, parallel supports that anchor tabs 12 and 14 by fitting into adjacent stator slots, as shown below with respect to FIG. 2. Legs 16 and 18 are separated by intra-leg sections 20 and 22, which have a width selected to match an installation distance between adjacent stator slots. Insulating tabs 12 and 14 are flexible, and may bend or twist as stator windings are secured during installation. Stator windings may, for example, be bound with lacing cord during installation, thereby twisting or bending insulating tabs 12 and 14. Intra-leg sections 20 and 22 are interior edges of insulating tabs 12 and 14, respectively, that extend from leg 16 to leg 18. In some embodiments intra-leg sections 20 and 22 may include slits 24 and 26 extending inward towards the center of tabs 12 and 14, respectively. Slits 24 and 26 provide additional flexibility to insulating tabs 12 and 14, allowing pole separator insert 10 to be further deformed during installation without tearing or breaking, and without compromising pole separator insert 10's ability to electrically separate adjacent winding coils of neighboring poles of each stator phase. In the depicted embodiment, slits 24 and 26 extend to substantially the center of insulating tabs 12 and 14, respectively.

FIG. 2 depicts four pole separator inserts 10 installed on stator assembly 100 to separate adjacent coils of neighboring poles of a single stator phase. Stator assembly 100 comprises stator core 102 (with stator teeth 104 defining stator slots 106, including stator slots 106a, 106b, 106c, and 106d) and stator windings 108 (including stator windings 108a and 108b). Pole separator insert 10 comprises insulating tab 14, legs 16 and 18, intra-leg section 22, and slit 26.

Stator assembly 100 is a stator section of an electrical machine such as a motor or generator. Stator core 102 is a substantially cylindrical structure formed of a ferromagnetic material such as steel. Stator core 102 has a plurality of circumferentially distributed, radially inward-extending stator teeth 104 that define axially-extending, circumferentially distributed stator slots 106 in stator core 102. Stator slots 106 house stator windings 108, which can, for instance, be windings of conductive wiring wrapped between two stator teeth 104, and axially through corresponding stator slots 106. In some embodiments, stator windings 108 may protected by an insulating sheath or enamel coating, at least where stator windings 108 do not pass through stator slots 106. This sheath or coating protects against electrical breakdown between different electrical coils (i.e. between stator windings of different phases, and/or of different poles of the same phase).

As shown in FIG. 2, all stator windings 108 are coils of four distinct poles of a single stator phase. In its fully assembled state, stator assembly 100 may further comprise an identical number of additional pole coils for each additional phase. A three phase generator, for instance, might comprise twelve distinct sets of stator windings 108. Although the illustrated embodiment of stator assembly 100 has four poles per phase, more or fewer poles are also possible. Stator assembly 100 may be constructed with any desirable number of phases.

In the depicted embodiment, stator winding 108a passes axially through and extends circumferentially between stator slots 106a and 106c. Similarly, stator winding 108b passes axially through and extends circumferentially between stator slots 106b and 106d. Stator windings 108a and 108b are windings of neighboring poles of the single phase illustrated in FIG. 2. Stator windings 108a and 108b are adjacent at stator slots 106c and 106d. At this location, electrical breakdown is a possibility between stator windings 108a and 108b, particularly where protective coatings and/or sheaths of stator windings 108 have been abraded or cracked, e.g. during installation. To prevent such electrical breakdowns, pole separator inserts 10 are disposed between such neighboring poles at locations of adjacency. For example, one such pole separator insert 10 is disposed with legs 16 and 18 through stator slots 106d and 106c, respectively, so as to prevent electrical contact between stator winding 108a and 108b. Legs 16 and 18 of pole separator insert 10 extend axially through stator slots 106d and 106c from one end of stator core 102 to the other. Insulating tabs 104 provide an electrical barrier at locations near slots 106c and 106d where stator windings 108a and 108b would otherwise directly abut. Insulating tab 12 extends similarly between stator slots 106c and 106d on the opposite side of stator core 102 (not shown). As discussed above with respect to FIG. 1, legs 16 and 18 of pole separator insert 10 are separated by intra-leg spacing 22, which is selected to slightly exceed the width of stator teeth 104. In this way, pole separator inserts 10 can be inserted readily into stator assembly 100 between adjacent stator coils during installation. Although description has focused for illustrative purposes on the arrangement of stator windings 108a and 108b and the core separator insert disposed between them, each set of neighboring stator windings of each phase has a corresponding coil separator insert. In the illustrated four-pole embodiment, four pole separator inserts 10 are included. Additional phases will similarly necessitate additional pole separator inserts 10. For example, an embodiment of stator assembly 10 with three phases of four poles each may include twelve pole separator inserts.

Stator assembly 100 is built by first installing one or more non-adjacent stator windings 108 on stator core 102. Stator windings 108 may, for instance, be wrapped wire-by-wire axially through and circumferentially between appropriate stator slots 106 (e.g. from stator slot 106b to stator slot 106d, for stator winding 108b). Next, pole separator inserts 10 are installed at locations where each stator windings 108 will eventually be adjacent to a stator windings 108 of a neighboring pole of the same phase (e.g. at stator slots 106c and 106d, in the same example). These neighboring poles of stator windings 108 are then installed with pole separator inserts 10 acting as insulators between adjacent windings (e.g. stator winding 108a between stator slots 106a and 106c). Stator windings 108 and pole separator inserts 10 may in some instances then be wrapped, cinched together, or compressed to form a compact body. Stator winding 108 may, for example, be bound together with lacing cord. This process may bend or twist core separator 10. Legs 16 and 18 retain insulating tabs 12 (see FIGS. 1) and 14 between adjacent stator windings of neighboring poles, despite this compression and bending and/or twisting. In some embodiments, intra-leg spacings 20 and 22 may include slits 24 and 26 that give insulating tabs 12 and 14, respectively, additional flexibility to handle bending and/or twisting during assembly without breaking or tearing.

Pole separator inserts 10 prevent electrical breakdowns and corresponding stator failures from shorting components by providing a barrier between adjacent stator windings 18 of neighboring poles of each phase. Insulating tabs 12 and 14 block electrical contact between adjacent stator windings, while legs 16 and 18 extend through neighboring stator slots 106 to retain insulating tab 12 and 14 in position. Legs 16 and 18 also offer physical separation to block electrical contact between adjacent stator windings as they pass through the stator core for their applicable slots. Intra-leg spacings 20 and 22 match the width of stator teeth 104, and slits 24 and 26 provide insulating tabs 12 and 14 with extra flexibility to handle twisting and bending during installation.

Discussion of Possible Embodiments

The following are non-exclusive descriptions of possible embodiments of the present invention.

A pole separator insert is employed in a stator assembly of an electric machine to separate winding coils installed within circumferentially distributed slots of a stator core. The pole separator insert comprises first and second insulating tabs connected by first and second legs. The first and second insulating tabs are disposed between adjacent winding coils of a single phase, at opposite ends of the stator core. The first and second legs are disposed through adjacent circumferentially distributed slots of the stator core.

The pole separator insert of the preceding paragraph can optionally include, additionally and/or alternatively, any one or more of the following features, configurations, and/or additional components:

The first and second insulating tabs are formed of dielectric paper or polymer film.

The first and second insulating tabs are formed of the same material as the first and second legs.

The first and second insulating tabs are substantially circular.

The first and second legs are parallel.

The first and second insulating tabs include intra-leg sections slightly wider than a distance between adjacent circumferentially distributed slots of the stator core.

The first and second insulating tabs include slits extending into the first and second tabs from the intra-leg sections to alleviate strain.

The slits extend from the intra-leg sections to substantially the center of each of the first and second insulating tabs.

A stator assembly for an electrical machine comprises a substantially cylindrical stator core, first and second conductive winding coils, and a pole separator insert. The substantially cylindrical core has a plurality of circumferentially distributed, axially extending slots including a first stator slot, a second stator slot, a third stator slot, and a fourth stator slot adjacent the third stator slot. The first conductive winding coil is wound through the first and third stator slots. The second conductive winding coil is of the same phase as the first conductive winding coil, and is wound through the second and fourth stator slots. The pole separator insert comprises first and second insulating tabs separating the first conductive winding from the second conductive winding coil, and first and second legs connecting the first and second insulating tabs, and extending through the third and fourth stator slots, respectively.

The stator assembly of the preceding paragraph can optionally include, additionally and/or alternatively, any one or more of the following features, configurations, and/or additional components:

The plurality of circumferentially distributed, axially extending slots are formed between a plurality of stator teeth.

The first and second insulating tabs are substantially circular.

The first and second insulating tabs are formed of dielectric paper of polymer filme.

The third stator slot is situated between the first and fourth stator slots, and the fourth stator slot is situated between the second and third stator slots.

The first and second insulating tabs include slits that allow the first and second insulating tabs to bend to alleviate strain.

The slits extend towards the center of each of the first and second insulating tabs from intra-leg sections between the first and second legs.

The phase of first and second winding coils constitutes four poles of windings.

The phase of the first and second winding coils constitutes one of a plurality of phases of windings on the substantially cylindrical stator core.

While the invention has been described with reference to an exemplary embodiment(s), it will be understood by those skilled in the art that various changes may be made and equivalents may be substituted for elements thereof without departing from the scope of the invention. In some embodiments, pole separator insert 10 may be combined with similar dedicated separator inserts disposed to prevent electrical contact between adjacent stator windings of different phases. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A pole separator insert employed in a stator assembly of an electric machine to separate winding coils installed within circumferentially distributed slots of a stator core, the pole separator insert comprising:
first and second insulating tabs disposed at opposite ends of the stator core, between adjacent winding coils of neighboring stator poles of a single phase; and
first and second legs connecting the first and second insulating tabs, and disposed through adjacent circumferentially distributed slots of the stator core.

2. The pole separator insert of claim 1, wherein the first and second insulating tabs are formed of dielectric paper or polymer film.

3. The pole separator insert of claim 1, wherein the first and second insulating tabs are formed of the same material as the first and second legs.

4. The pole separator insert of claim 1, wherein the first and second insulating tabs are substantially circular.

5. The pole separator insert of claim 1, wherein the first and second legs are parallel.

6. The pole separator insert of claim 1, wherein the first and second insulating tabs include intra-leg sections slightly wider than a distance between adjacent circumferentially distributed slots of the stator core.

7. The pole separator insert of claim 6, wherein the first and second insulating tabs include strain slits extending into the first and second tabs from the intra-leg sections to alleviate strain.

8. The pole separator insert of claim 7, wherein the strain slits extend from the intra-leg sections to substantially the center of each of the first and second insulating tabs.

9. A stator assembly for an electric machine, the stator assembly comprising:
a substantially cylindrical stator core with a plurality of circumferentially distributed, axially extending slots including a first stator slot, a second stator slot, a third stator slot, and a fourth stator slot adjacent the third stator slot;
a first pole of conductive winding wound through the first and third stator slots;
a second pole of conductive winding coil of the same phase as the first pole of conductive winding, and wound through the second and fourth stator slots;
a pole separator insert comprising:
first and second insulating tabs separating the first pole of conductive winding from the second pole of conductive winding; and
first and second legs connecting the first and second insulating tabs, and extending through the third and fourth stator slots, respectively.

10. The stator assembly of claim 9, wherein the plurality of circumferentially distributed, axially extending slots are formed between a plurality of stator teeth.

11. The stator assembly of claim 9, wherein the first and second insulating tabs are substantially circular.

12. The stator assembly of claim 9, wherein the first and second insulating tabs are formed of dielectric paper or polymer film.

13. The stator assembly of claim 9, wherein the third stator slot is situated between the first and fourth stator slots, and the fourth stator slot is situated between the second and third stator slots.

14. The stator assembly of claim 9, wherein the first and second insulating tabs include slits that allow the first and second insulating tabs to bend to alleviate strain.

15. The stator assembly of claim 14, wherein the slits extend towards the center of each of the first and second insulating tabs from intra-leg sections between the first and second legs.

16. The stator assembly of claim 9, wherein the phase of first and second poles of conductive windings constitutes four winding cores.

17. The stator assembly of claim 9, wherein the phase of the first and second poles of conductive windings constitutes one of a plurality of phases of windings on the substantially cylindrical stator core.
